(19) United States
(12) Patent Application Publication
(10) Pub. No.: US 2023/0106671 A1
(43) Pub. Date: Apr. 6, 2023

(54) VALVE DEVICE

(71) Applicant: FUTABA INDUSTRIAL CO., LTD., Aichi (JP)

(72) Inventors: Koji Kanazumi, Okazaki-shi (JP); Yusuke Tsuzuki, Okazaki-shi (JP); Hirosato Kato, Okazaki-shi (JP); Takehiro Miura, Okazaki-shi (JP)

(21) Appl. No.: 17/957,442

(22) Filed: Sep. 30, 2022

(30) Foreign Application Priority Data
Oct. 4, 2021 (JP) 2021-163637

(51) Int. Cl. F16K 1/42; F01N 13/08

(52) U.S. Cl. CPC F16K 1/42; F01N 13/08

(57) ABSTRACT

A valve device includes a valve seat, a valve body, a buffer, and a non-overlapping portion. The valve seat has an opening that communicates with an exhaust flow path. The valve body is configured to open and close at least a part of the opening. The buffer is disposed between the valve seat and the valve body and is more flexible than the valve seat. The non-overlapping portion is configured so that the valve seat and the valve body do not overlap each other in an opening and closing direction of the valve body at at least a part of an outer periphery of the valve body in a state where the valve body is closed.

### CROSS-REFERENCE TO RELATED APPLICATIONS

This application claims the benefit of Japanese Patent Application No. 2021-163637 filed Oct. 4, 2021 in the Japan Patent Office, the entire disclosure of which is incorporated herein by reference.

### BACKGROUND

The present disclosure relates to a valve device disposed in an exhaust flow path.

Japanese Unexamined Patent Application Publication No. 2016-151192 discloses a valve device disposed on a side surface of a pipe constituting an exhaust flow path. The valve device includes an opening and a valve body, and includes a buffer between the opening and the valve body.

### SUMMARY

In the configuration of Japanese Unexamined Patent Application Publication No. 2016-151192, the buffer suppresses abnormal noise when the valve body and the opening of the pipe collide. However, cushioning properties of the buffer may be deteriorated over time. In such a case, there is a problem that abnormal noise when the valve body collides with the opening via the buffer is loud. One phase of the present disclosure is to suppress abnormal noise caused by opening and closing of a valve body in a valve device.

One aspect of the present disclosure is a valve device disposed in an exhaust flow path. The valve device includes a valve seat, a valve body, a buffer, and a non-overlapping portion. The valve seat has an opening that communicates with the exhaust flow path. The valve body is configured to open and close at least a part of the opening.

The buffer is disposed between the valve seat and the valve body and is more flexible than the valve seat. The non-overlapping portion is configured so that the valve seat and the valve body do not overlap each other in an opening and closing direction of the valve body at at least a part of an outer periphery of the valve body in a state where the valve body is closed.

Such a configuration includes the non-overlapping portion, and thus the valve body can be configured to be less likely to collide with the valve seat. The buffer can alleviate an impact when the valve body is opened and closed. Therefore, abnormal noise caused by opening and closing of the valve body can be suppressed.

In one aspect of the present disclosure, the buffer may be disposed so as to protrude from the valve seat or the valve body toward the non-overlapping portion.

In such a configuration, the buffer can close at least a part of the non-overlapping portion. Therefore, this configuration can improve airtightness in the non-overlapping portion.

In one aspect of the present disclosure, a valve shaft and an overlapping portion may be further provided. The valve shaft may be disposed in one direction around the opening. The valve body may be configured to be opened and closed by using the valve shaft. The overlapping portion may be configured so that the valve seat and the valve body overlap each other in the opening and closing direction of the valve body at a portion closer to the valve shaft around the opening in a state where the valve body is closed.

In to such a configuration, the overlapping portion can suppress excessive movement of the valve body. Since the overlapping portion is set at a portion closer to the valve shaft where moment applied to the valve body is relatively small, it is possible to suppress generation of loud abnormal noise.

In one aspect of the present disclosure, the opening may have a quadrangular shape, and the valve shaft may be disposed along one side constituting the quadrangular shape. The non-overlapping portion may be provided along at least one of both sides adjacent to at least a side of the quadrangular shape, the side being closest to the valve shaft.

The quadrangular shape includes a quadrangular shape and a substantially quadrangular shape in plan view. The plan view is a line of sight when an object is viewed from one direction as a plan diagram. The substantially quadrangular shape is a shape that looks approximately quadrangular.

In such a configuration, since the non-overlapping portion is provided along the sides of the valve body, abnormal noise generated from the sides of the valve body can be suppressed.

In one aspect of the present disclosure, a thickness of the buffer may be set to be greater than or equal to a width of the non-overlapping portion.

Such a configuration can secure the cushioning properties of the buffer and satisfactorily close the non-overlapping portion by the buffer.

### BRIEF DESCRIPTION OF THE DRAWINGS

An example embodiment of the present disclosure will be described hereinafter by way of example with reference to the accompanying drawings, in which:

FIG. 1 is an external view of a valve device according to an embodiment;

FIG. 2 is a sectional view taken along line II-II in FIG. 1;

FIG. 3 is a schematic view showing an arrangement of a buffer;

FIG. 4 is a sectional view taken along line IV-IV in FIG. 1;

FIG. 5 is a graph showing a relationship between a rotation speed of an internal combustion engine and a noise level at a time of acceleration;

FIG. 6 is a graph showing a relationship between the rotation speed of the internal combustion engine and the noise level at a time of deceleration; and

FIG. 7 is a central sectional view of a valve device according to another embodiment.

### DETAILED DESCRIPTION OF EXEMPLARY EMBODIMENTS

Hereinafter, an exemplary embodiment of the present disclosure will be described with reference to the drawings.

### 1. Embodiment

### 1-1. Configuration

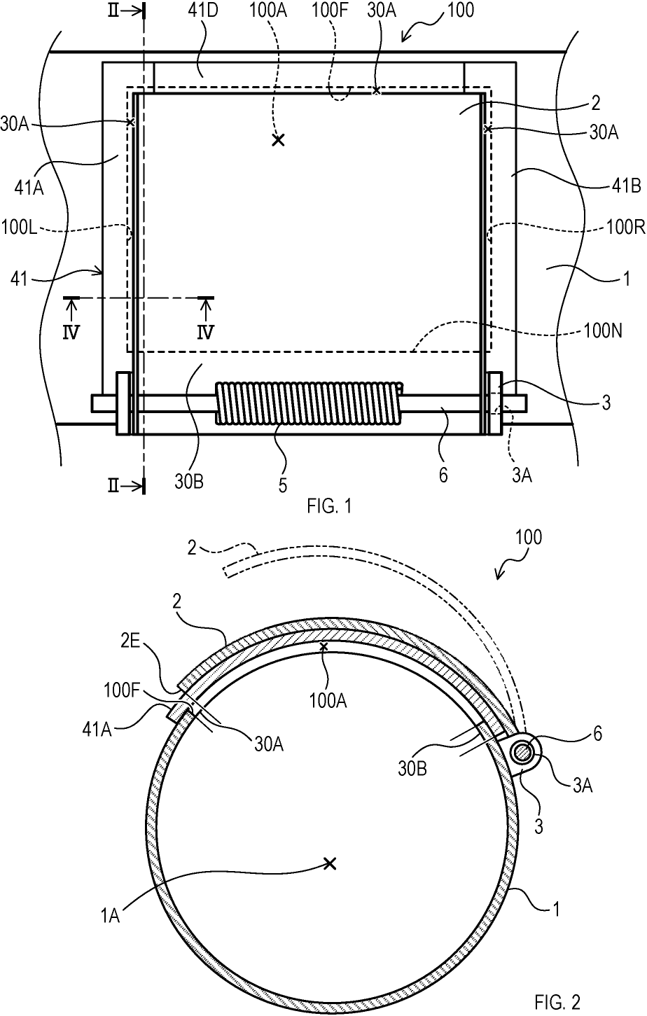

A valve device 100 according to the embodiment illustrated in FIGS. 1 and 2 is provided in an exhaust flow path 1A for exhaust gas discharged from an internal combustion engine such as an engine. The internal combustion engine can be mounted on a vehicle, an aircraft, a generator, or the like. The valve device 100 is attached to, for example, a side surface of a pipe 1 constituting a muffler. An opening 100A, which is a connection port to a bypass flow path, is formed on the side surface of the pipe 1. The valve device 100 is configured to open and close the opening 100A from outside of the pipe 1.

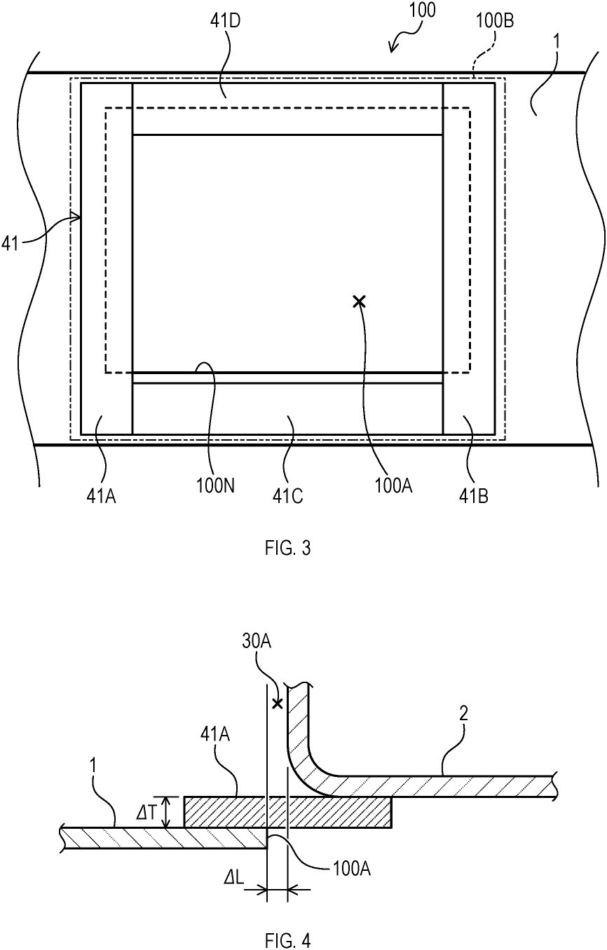

The valve device 100 includes the pipe 1, a valve body 2, a support 3, a buffer 41, a spring 5, and a shaft 6. The pipe 1 has a cylindrical shape, and forms the exhaust flow path 1A in the muffler. The pipe 1 has a function of discharging the exhaust gas flowing into the pipe 1 to a downstream side. As illustrated in FIGS. 1 and 3, the pipe 1 includes the opening 100A and a valve seat 100B.

The opening 100A is an opening formed on the side surface of the pipe 1 and configured to communicate inside and outside of the pipe 1. The valve seat 100B is indicated as a region around the opening 100A in the pipe 1, and as a region covered by the valve body 2 when the valve body 2 closes the pipe 1 and a region where the buffer 41 is disposed in a region not covered by the valve body 2. The opening 100A has a quadrangular shape, particularly a rectangular shape in plan view.

Note that the opening 100A may have a substantially quadrangular shape obtained by rounding or chamfering corners of a quadrangle. The shape of the opening 100A is not necessarily a quadrangle, but any shape can be adopted. The opening 100A can adopt, for example, a substantially triangular shape, a circular shape, an elliptical shape, or the like.

The valve body 2 is a member having a curved surface shape corresponding to an outer surface shape of the pipe 1. The valve body 2 is provided with a hole (not illustrated) into which the shaft 6 is inserted. The valve body 2 is configured separately from the support 3 that supports the shaft 6. The valve body 2 is rotatably supported with respect to the support 3 about the shaft 6. The shaft 6 functions as a valve shaft.

The valve device 100 is configured to open and close at least a part of the opening 100A by opening and closing operation of the valve body 2. This opening and closing operation enables the valve device 100 to adjust a flow rate of the exhaust gas flowing to the downstream side of the pipe 1.

The valve body 2 is configured to be opened and closed by using the shaft 6 disposed in any one direction around the opening 100A.

The support 3 is provided close to the opening 100A, and supports the shaft 6 along an axial direction of the pipe 1. The support 3 rotatably supports the valve body 2 via the shaft 6 as described above. The support 3 is provided with a shaft hole 3A into which the shaft 6 is inserted.

The shaft 6 is disposed parallel to one side of the opening 100A, that is, one side constituting the quadrangle described above. In the present embodiment, the shaft 6 is disposed along an opening side 100N in one direction around the opening 100A, and a longitudinal direction of the shaft 6 is disposed in a direction parallel to a flow direction of the exhaust gas in the exhaust flow path 1A. The opening side 100N is a lower side of the opening 100A in FIG. 1.

The four sides of the quadrangle constituting the opening 100A will be denoted as opening sides 100N, 100F, 100R, and 100L below. The opening side 100N is a side closest to the shaft 6 among the four sides constituting the opening 100A. The opening side 100F is a side farthest from the shaft 6. The opening side 100R is a side positioned on the right when the opening 100A is viewed from the shaft 6. Similarly, the opening side 100L is a side positioned on the left.

The spring 5 is provided around the shaft 6 in a circumferential direction of the shaft 6 in a state where the shaft 6 is inserted into the spring 5. One end of the spring 5 is in contact with at least one of the pipe 1 or the support body 3, and the other end of the spring 5 is in contact with the valve body 2. The spring 5 has a function of biasing the valve body 2 in a direction of closing the opening 100A.

As illustrated in FIG. 3, the buffer 41 is provided on the valve seat 100B. The buffer 41 is disposed on an outer peripheral surface of the pipe 1 and on an outer periphery of the opening 100A. In this configuration, the buffer 41 can be disposed along an outer periphery of the pipe 1 while being pulled during an assembling operation. Therefore, workability can be improved as compared with a case where the buffer 41 is disposed along an inner periphery of the pipe 1.

The buffer 41 is disposed between the valve seat 100B and the valve body 2 and has a sheet shape with a constant thickness. The buffer 41 is more flexible than the valve seat 100B. Being flexible means that the buffer 41 is configured so that an impact when the valve body 2 touches the valve seat 100B via the buffer 41 is smaller than an impact when the valve body 2 directly touches the valve seat 100B.

For example, a material constituting the buffer 41 may include a material having hardness lower than hardness of the valve seat 100B (for example, the pipe 1). When the hardness of the material is high, the buffer 41 may be processed to have cushioning properties. That is, the buffer 41 may be configured to absorb an impact for having cushioning properties.

Specifically, the buffer 41 is made of metal, for example, and is configured as a mesh member such as a wire mesh. This configuration is to provide cushioning properties and durability. For example, stainless steel (SUS) can be adopted for the valve seat 100B, and SUS mesh can be adopted for the buffer 41. The buffer 41 has a thickness of, for example, about 1 mm to 4 mm. The thickness and mesh shape of the buffer 41 are preferably set in consideration of an increase in resistance due to an increase in a distance of the flow path when the exhaust gas passes near the buffer 41.

The buffer 41 is joined to the valve seat 100B by spot welding or the like, for example. As illustrated in FIGS. 1 and 3, the buffer 41 includes a first buffer sheet 41A and a second buffer sheet 41B. The first buffer sheet 41A and the second buffer sheet 41B are disposed so as to sandwich the opening 100A from both sides in the axial direction of the pipe 1 (left and right in FIGS. 1 and 3). The buffer 41 also includes a third buffer sheet 41C and a fourth buffer sheet 41D. The third buffer sheet 41C and the fourth buffer sheet 41D are disposed so as to sandwich the opening 100A from both sides in a direction orthogonal to the axial direction of the pipe 1 (left and right in FIGS. 1 and 3).

The third buffer sheet 41C is disposed along the opening side 100N closer to the shaft 6. The fourth buffer sheet 41D is disposed along the opening side 100F farther from the shaft 6.

As illustrated in FIG. 3, the first buffer sheet 41A, the second buffer sheet 41B, and the fourth buffer sheet 41D of the buffer 41 are disposed so as to protrude from the valve seat 100B toward the opening 100A. In other words, the buffer sheets 41A, 41B, and 41D are disposed so as to protrude toward a non-overlapping portion 30A described later. The third buffer sheet 41C is disposed without protruding toward the opening 100A. That is, the third buffer sheet 41C is disposed so as to overlap the valve seat 100B in plan view.

The valve device 100 includes the non-overlapping portion 30A and an overlapping portion 30B. As illustrated in FIGS. 1 and 4, the non-overlapping portion 30A is a portion configured so that the valve seat 100B and the valve body 2 do not overlap each other in an opening and closing direction of the valve body 2.

The non-overlapping portion 30A is formed along an outer periphery of a surface of the valve body 2 close to the valve seat 100B. That is, the non-overlapping portion 30A is a gap with the valve body 2 extending along an edge of the opening 100A. In other words, the non-overlapping portion 30A is a region where the valve seat 100B and the valve body 2 are separated from each other in a plan view in a state where the valve body 2 is closed.

As illustrated in FIG. 4, a width ΔL of the gap is set to about 0 mm to 4 mm. The width ΔL of the gap is preferably greater than 0. A thickness ΔT of the buffer 41 is set to be greater than or equal to the width ΔL of the non-overlapping portion 30A. Note that the width ΔL of the non-overlapping portion 30A represents a length in a direction from one opening side 100N, 100R, or 100L of the opening 100A toward the opposing opening side 100F, 100L, or 100R.

The non-overlapping portion 30A is formed along a distal end and sides of the valve body 2 in the opening 100A. Specifically, the non-overlapping portion 30A is formed along three sides which are the opening side 100F farther from the shaft 6 and the opening sides 100R and 100L on both sides of the opening side 100F.

Here, in a valve device of a conventional configuration, the valve body and the valve seat are configured to overlap each other on an entire periphery of the valve body. However, in the valve device 100 according to the present embodiment, except at least a part of the valve body 2 and the valve seat 100B, the valve body 2 and the valve seat 100B do not overlap each other and are configured as the non-overlapping portion 30A.

In the non-overlapping portion 30A, the valve seat 100B does not exist in a moving direction of the valve body 2, and the buffer 41 disposed so as to protrude toward the opening 100A exists. In other words, in the non-overlapping portion 30A, the valve body 2 and the valve seat 100B do not overlap each other, but the valve body 2 and the buffer 41 overlap each other.

In such a configuration, the valve body 2 does not close an entire area of the opening 100A with the valve body 2 alone. However, the valve body 2 and the buffer 41 are configured to cooperate with each other to close substantially the entire area of the opening 100A.

As illustrated in FIG. 2, a length of the valve body 2 from the shaft 6 to a distal end 2E is set so that the distal end 2E of the valve body 2 does not reach the opening side 100F farther from the shaft 6. A width (that is, a length in a left-right direction in FIG. 1) of the valve body 2 is set so as not to cover the opening sides 100R and 100L on both sides.

The distal end 2E of the valve body 2 and the sides of the valve body 2 (that is, both ends of the valve body 2 in the left-right direction in FIG. 1) are prevented from moving in a closing direction of the valve body 2 at a position where the valve body 2 touches the buffer 41 such as the first buffer sheet 41A.

As illustrated in FIG. 2, the overlapping portion 30B is a portion configured so that the valve seat 100B and the valve body 2 overlap each other in the opening and closing direction of the valve body 2. The overlapping portion 30B is configured along the opening side 100N closer to the shaft 6.

### 1-3. Effects

The embodiment described in detail above exerts the following effects.

(1a) One aspect of the present disclosure is a valve device 100 disposed in an exhaust flow path 1A. The valve device 100 includes a valve seat 100B, a valve body 2, a buffer 41, and a non-overlapping portion 30A. The valve seat 100B has an opening 100A that communicates with the exhaust flow path 1A. The valve body 2 is configured to open and close at least a part of the opening 100A. The buffer 41 is disposed between the valve seat 100B and the valve body 2 and is more flexible than the valve seat 100B.

The non-overlapping portion 30A is configured so that the valve seat 100B and the valve body 2 do not overlap with each other in an opening and closing direction of the valve body 2 at a part of an outer periphery of the valve body 2 in a state where the valve body 2 is closed.

Such a configuration includes the non-overlapping portion 30A, and thus the valve body 2 can be configured to be less likely to collide with the valve seat 100B. The buffer 41 can alleviate an impact when the valve body 2 is opened and closed. Therefore, abnormal noise caused by opening and closing of the valve body 2 can be suppressed.

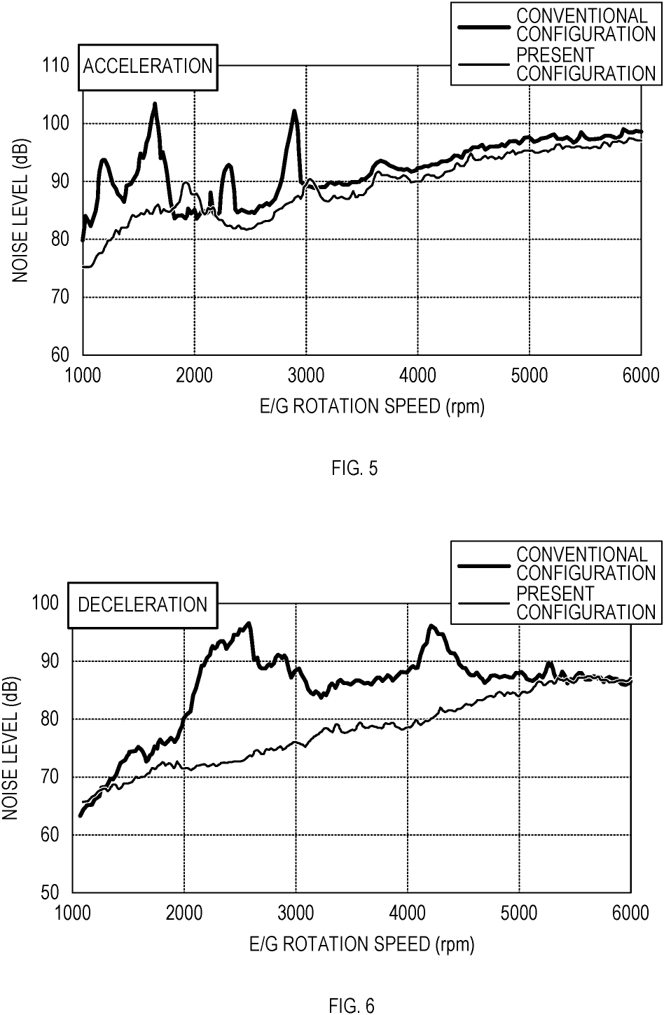

(1b) Experimental results for describing the above effects are shown in FIGS. 5 and 6. In FIGS. 5 and 6, a valve device having a configuration including the non-overlapping portion 30A on an entire circumference of the opening 100A is adopted as the “present configuration”. A valve device having a configuration not including the non-overlapping portion 30A and using a buffer after aged deterioration is adopted as the “conventional configuration”.

FIG. 5 illustrates a measurement result of a noise level in a case where the rotation speed of the internal combustion engine is increased with time, and FIG. 6 illustrates a measurement result of the noise level in a case where the rotation speed of the internal combustion engine is decreased with time. As can be seen from FIGS. 5 and 6, in any case, the noise level of the present configuration is reduced as a whole as compared with the conventional configuration.

(1c) In one aspect of the present disclosure, the buffer 41 is disposed on the valve seat 100B or the valve body 2 so as to protrude toward the non-overlapping portion 30A.

In such a configuration, the buffer 41 can close at least a part of the non-overlapping portion 30A. Therefore, airtightness in the non-overlapping portion 30A can be improved.

(1d) In one aspect of the present disclosure, the valve body 2 is configured to be opened and closed by using the shaft 6 disposed in one direction around the opening 100A. The overlapping portion 30B is configured so that the valve seat 100B and the valve body 2 overlap each other in the opening and closing direction of the valve body 2 at a portion closer to the shaft 6 around the opening 100A in a state where the valve body 2 is closed.

In such a configuration, since the overlapping portion 30B is provided at a portion closer to the shaft 6 around the opening 100A, the overlapping portion 30B can suppress excessive movement of the valve body 2. Since the overlapping portion 30B is set at a portion closer to the shaft 6 where moment applied to the valve body 2 is relatively small, it is possible to suppress generation of loud abnormal noise. The excessive movement of the valve body 2 indicates that there is a possibility that the durability of the buffer 41 and the opening and closing of the valve body 2 are adversely affected, for example, the buffer 41 is deteriorated by the valve body 2 pushing the buffer 41 excessively in the moving direction.

(1e) In one aspect of the present disclosure, the opening 100A has a quadrangular shape, and the shaft 6 is disposed along one side constituting the quadrangular shape. The non-overlapping portion 30A is provided along at least one of both sides adjacent to at least a side of the quadrangular shape, the side being closest to the shaft 6.

In such a configuration, since the non-overlapping portion 30A is provided along the sides of the valve body 2, abnormal noise generated from the sides of the valve body 2 can be suppressed.

(1f) In one aspect of the present disclosure, the buffer 41 is disposed on the valve seat 100B.

In such a configuration, since the buffer 41 can be disposed along an outer periphery of the exhaust flow path 1A, the buffer 41 can be assembled to the valve seat 100B while being pulled. Thus, the assembling operation can be performed more easily than in a case where the buffer 41 is disposed along an inner periphery of the exhaust flow path 1A. In such a configuration, when the exhaust gas passes near the opening 100A, the buffer 41 suppresses a flow velocity of the exhaust gas. The buffer 41 can be configured to obstruct a flow of the exhaust gas when being deformed by the flow of the exhaust gas. Accordingly, abnormal noise caused by the flow of the exhaust gas can be suppressed.

(1g) In one aspect of the present disclosure, the thickness ΔT of the buffer 41 is greater than or equal to the width ΔL of the non-overlapping portion 30A.

Such a configuration can secure the cushioning properties of the buffer 41 and satisfactorily close the non-overlapping portion 30A by the buffer 41.

### 2. Other Embodiments

Although the embodiment of the present disclosure has been described above, the present disclosure is not limited to the above embodiment, and various modifications can be made.

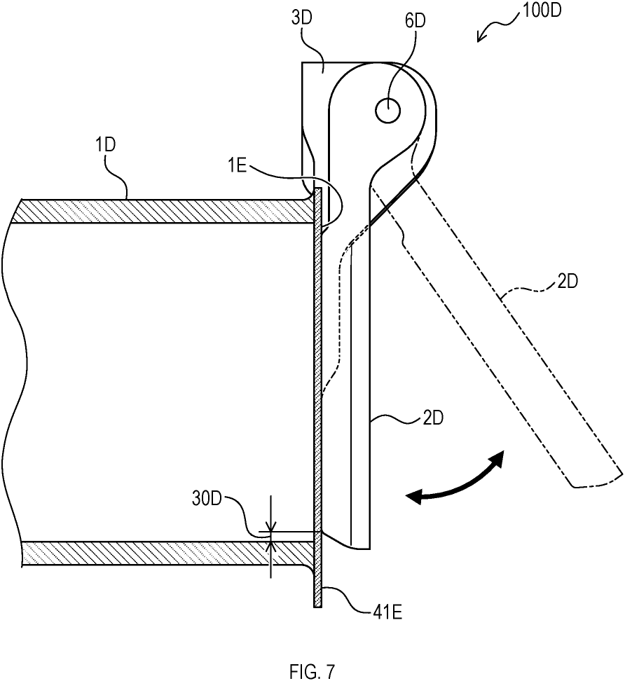

(2a) In the embodiment, the present disclosure is applied to the valve device 100 as a side valve disposed on the side of a central axis of the pipe 1, but this configuration is not necessary. For example, the present disclosure can be applied to a valve device 100D as an end valve disposed on the central axis of the pipe 1 as illustrated in FIG. 7.

The valve device 100D illustrated in FIG. 7 is an end valve disposed in an opening 1E at an end of a pipe 1D. The valve device 100D includes a valve body 2, a support 3D, a shaft 6D, and a buffer 41E. The opening 1E functions as a valve seat. The valve body 2 is configured to be rotatable about the support 3D via the shaft 6D, and the opening 1E is opened and closed by operation of the valve body 2.

The buffer 41E has an annular shape, is disposed over an entire circumference of the opening 1E, and is fixed to the opening 1E.

The valve device 100D also includes a non-overlapping portion 30D. The non-overlapping portion 30D is a portion configured so that the valve seat 100B and the valve body 2 (for example, a contact surface 2F which is a surface of the valve body 2 in contact with the buffer 41E) do not overlap each other in the opening and closing direction of the valve body 2 at a part of the outer periphery of the valve body 2D in a state where the valve body 2D is closed.

The buffer 41E is disposed so as to protrude toward the non-overlapping portion 30D, and the valve body 2 is prevented from moving in the opening and closing direction by touching the buffer 41E.

As described above, the configuration of the present disclosure can be also favorably applied as an end valve.

(2b) In the valve device 100 according to the embodiment, the non-overlapping portion 30A is disposed along the distal end and the sides of the valve body 2, but this configuration is not necessary. For example, the non-overlapping portion 30A may be provided at least at a part of the periphery of the valve body 2, such as only the distal end or only the sides of the valve body 2.

(2c) A plurality of functions of one component in the embodiment may be implemented by a plurality of components, or one function of one component may be implemented by a plurality of components. A plurality of functions of a plurality of components may be implemented by one component, or one function implemented by a plurality of components may be implemented by one component. A part of a configuration of the embodiment may be omitted. At least a part of a configuration of the embodiment may be added to or replaced with another configuration of the embodiment.

(2d) In addition to the valve device 100 and 100D described above, the present disclosure can be implemented in various forms such as a system including the valve device 100 or 100D as a component.

What is claimed is:

1. A valve device comprising:
a valve seat;
a valve body;
a buffer; and
a non-overlapping portion, wherein
the valve seat includes an opening that communicates with an exhaust flow path,
the valve body is configured to open and close at least a part of the opening,
the buffer is disposed between the valve seat and the valve body and is more flexible than the valve seat, and
the non-overlapping portion is configured so that the valve seat and the valve body do not overlap at least a part of an outer periphery of the valve body in an opening and closing direction of the valve body in a state where the valve body is closed.

2. The valve device according to claim 1, wherein the buffer is disposed to protrude from the valve seat or the valve body toward the non-overlapping portion.

3. The valve device according to claim 1, further comprising:
a valve shaft; and
an overlapping portion, wherein
the valve shaft is disposed in one direction around the opening,
the valve body is configured to be opened and closed by using the valve shaft, and
the overlapping portion is a portion closer to the valve shaft around the opening in a state where the valve body is closed, and is a portion configured so that the valve seat and the valve body overlap each other in the opening and closing direction of the valve body.

4. The valve device according to claim 3, wherein
the opening has a quadrangular shape,
the valve shaft is disposed along one side constituting the quadrangular shape, and
the non-overlapping portion is provided along at least one of both sides adjacent to at least a side closest to the valve shaft of the quadrangular shape.

5. The valve device according to claim 1, wherein the buffer has a thickness that is greater than or equal to a width of the non-overlapping portion.
